(19) United States
(12) Patent Application Publication
(10) Pub. No.: US 2020/0189649 A1
(43) Pub. Date: Jun. 18, 2020

(54) STEER-BY-WIRE STEERING SYSTEM OF A MOTOR VEHICLE WITH A FEEDBACK ACTUATOR HAVING AN INTEGRATED MRF BEARING

(71) Applicants: THYSSENKRUPP PRESTA AG, Eschen (LI); thyssenkrupp AG, Essen (DE)

(72) Inventors: Kristof POLMANS, Tarrenz (AT); Imre SZEPESSY, Mauren (LI); Arne SCHACHT, Feldkirch (AT); Markus DOLD, Sevelen (CH)

(73) Assignees: THYSSENKRUPP PRESTA AG, Eschen (LI); thyssenkrupp AG, Essen (DE)

(21) Appl. No.: 16/638,844

(22) PCT Filed: Aug. 29, 2017
(86) PCT No.: PCT/EP2017/071644

§ 371 Date: Feb. 13, 2020

(51) Int. Cl. B62D 5/00; F16C 19/08; F16C 41/00

(52) U.S. Cl. CPC B62D 5/006; B62D 5/0427; F16C 41/00; F16C 19/08

(57) ABSTRACT

A steer-by-wire steering system for a motorized vehicle includes a feedback actuator to simulate a steering feel to a steering device. The feedback actuator has an electric motor with a motor shaft connected to a driver input shaft to be able to transmit a torque. The motor shaft is able to be rotated in at least one rolling bearing. The rolling elements of the at least one rolling bearing are arranged in a magnetorheological fluid and the feedback actuator further includes an electromagnet to pass a magnetic field through said magnetorheological fluid for stiffening the fluid and restricting movement of the rolling element.

The present invention relates to a steer-by-wire steering system of a motor vehicle according to the preamble of claim 1.

In a steer-by-wire steering system, the vehicle's steering wheel is disengaged from the steering mechanism. Steering movement is achieved by a steering actuator with an electric motor. The steering actuator operates in response to detected values of various steering parameters, such as steering wheel angle and vehicle speed etc. The detected values are communicated electronically to the steering actuator from sensors, whereby the electric motor drives the rack and orients the steerable wheels in the desired direction. The steering actuator could be called steering gear.

Even though the mechanical linkage between the steering wheel and the road wheels has been eliminated, a steer-by-wire steering system is expected to produce the same functions and steering feel as a conventional mechanically linked steering system. The forces generated in moving the road wheels have to be fed back to the steering wheel to provide information for directional control of the vehicle to the driver. The feedback also contributes to a feeling of steering referred to as steering feel. In steer-by-wire steering systems the feedback and steering feel respectively is generated with a feedback actuator connected to the steering wheel.

The patent application DE 10 2015 210 528 A1 discloses a feedback actuator with a damping device including spring elements, which introduces a damping torque into the steering shaft opposite to a steering toque. Drawbacks of this feedback actuator are its large build volume and complex construction.

It is an object of the present invention to provide an improved feedback actuator in a steer-by-wire steering system of a motor vehicle, which generates a better steering feel while having a space-saving and simple design.

This object is achieved by a steer-by-wire steering system of a motor vehicle having the features of claim 1.

Accordingly, a steer-by-wire steering system for a motorized vehicle comprising a feedback actuator to simulate a steering feel to a steering device is provided, wherein said feedback actuator has an electric motor with a motor shaft connected to a driver input shaft to be able to transmit a torque, wherein said motor shaft is able to be rotated in at least one rolling bearing, and wherein the rolling elements of the at least one rolling bearing are arranged in a magnetorheological fluid and wherein the feedback actuator further comprises means to pass a magnetic field through said magnetorheological fluid for stiffening said fluid and restricting movement of said rolling elements. This magnetorheologic fluid brake element allows for passive force feedback. Feedback actuator motor torque and costs are this way drastically reduced.

Preferably, the means to pass a magnetic field through said magnetorheological fluid includes a ring-shaped coil.

It is advantageous, if the coil is arranged in the at least one rolling bearing housing, wherein the at least one rolling bearing housing is preferably filled with the magnetorheological fluid. The MRF damping device is this way designed as one integrated unit and there is no need for extra packaging space.

In a preferred embodiment, the motor shaft is able to be rotated in an upper bearing and a lower bearing, wherein the upper bearing holds the free end of the motor shaft and the lower bearing is positioned at the opposite side of the motor's rotor. In that regard, the rolling elements of the lower bearing are preferably arranged in a magnetorheological fluid.

Further the motor shaft can hold a motor pulley as part of a transmission gear, wherein the transmission gear includes a belt connected on one side to the motor pulley and on another side to a pulley arranged on the driver input shaft. Alternatively, the motor shaft can hold a first gear and the drive input shaft can hold a second gear, wherein the first gear meshes the second gear. Preferably, the first gear is a worm and the second gear is a worm wheel.

Alternatively, the motor shaft can be coupled directly to the driver input shaft.

One exemplary embodiment of the present invention is described below with aid of the drawings. In all figures the same reference signs denote the same components or functionally similar components.

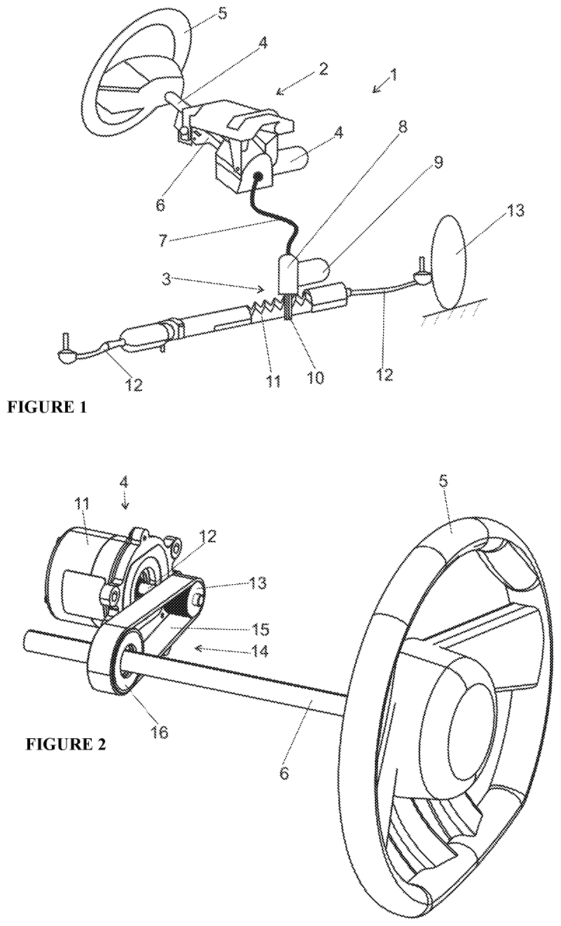

FIG. 1 shows a steer-by-wire steering system in a schematic illustration,

FIG. 2 shows a schematic illustration of a feedback actuator, and

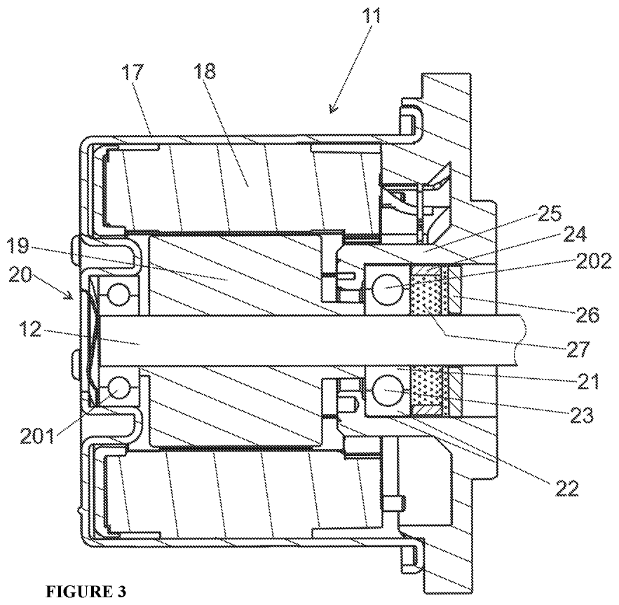

FIG. 3 shows a longitudinal cut of an electric motor of the feedback actuator.

FIG. 1 is a schematic representation of a steer-by-wire steering system 1 that comprises an actuation control system 2 to actuate road wheels 3 and a feedback actuator 4 to simulate the steering feel of a conventional mechanically linked steering system. A steering device 5, which is in the example a steering wheel, is connected to a driver input shaft 6. Position sensors 7 and torque sensor 8 are operably connected to driver input shaft 6. Position sensors 7 electronically detect the angular position of the driver input shaft 6, while the torque sensor 8 electronically detects and evaluates the torsional force acting on the driver input shaft 6. The angular displacement of the steering wheel 5 is detected, transmitted to the actuation control system 2, processed in the actuation control system 2, and applied to a servo motor 9 to move the steerable road wheels 3 via a rack 101 and pinion 102 system 10.

As shown in FIG. 2, the feedback actuator 4 includes an electric motor 11 having a motor shaft 12 rotatively driven by the motor 11 and connected to the driver input shaft 6. Since there is no direct mechanical coupling between the actuation control system and the steerable wheels, the driver does not receive any feedback from the road surface through the steering mechanism. Therefore, the feedback actuator 4 generates a reaction torque to the steering wheel 5, based upon a number of steering parameters such as vehicle speed, steering device angle, the steering device angle speed, the steering device turning acceleration, the yaw rate of the vehicle, road surface condition, and further driving parameters of the vehicle.

Formed into or onto the motor shaft 12 is a motor pulley 13 as part of a transmission gear 14. Attached to the motor pulley 13 is a belt 15 driving a pulley 16 connected to the driver input shaft 6.

The electric motor 11 as depicted in FIG. 3 includes a motor housing 17 incorporating a stator 18. A rotor 19 is configured to rotate together with the motor shaft 12. The motor shaft 12 is allowed to rotate in bearing assemblies 20. The bearing assemblies 20 include an upper bearing 201 and a lower bearing 202, wherein the upper bearing 201 holds the free end of the motor shaft 12 facing away from the transmission gear (not shown) and the lower bearing 202 is positioned at the opposite side of the rotor 19. The lower bearing 202 has an inner bearing ring 21 and outer bearing ring 22 holding the rolling elements 23. At the front side of the outer bearing ring 22 a ring-shaped coil 24 functioning as an electromagnet is arranged. The coil 24 is arranged in the bearing housing 25 with the bearing 202 on one side and a cover 26 on the other side. The bearing housing 25 is filled with a magnetorheological fluid (MRF) 27. The bearing 202 comprises a seal to avoid that the magnetorheological fluid 27 can flow inside the electric motor 11.

When subjected to a magnetic field, the MRF 27 greatly increases its apparent viscosity, to the point of becoming a viscoelastic solid. This way the yield stress of the MRF can be controlled very accurately by varying the magnetic field intensity.

Thus, when a magnetic field is created by running an electric current from a power source, not shown, through the coil 24, the magnetorheological fluid 27 becomes stiffened (higher viscosity), so that a higher torque to rotate the ball bearing 202 and thereby a higher torque to rotate the motor shaft 12 is necessary and the movement of the motor shaft will be braked. Furthermore, the current could be increased and the magnetorheological fluid 27 becomes solidified therebetween, preventing movement of ball bearing 202 and thereby preventing movement of the motor shaft 12. When the power is off and the magnetorheological fluid 27 is a free-flowing liquid, it offers little resistance to the ball bearing's movement.

The bearing according to the present invention makes it possible to continuously control the damping rate by changing the viscosity of the MRF. End position lock of the steering wheel with high torque is possible, as well as curb-push off and curb damage protection. Even in case of electric motor failure damping can be carried out.

Ball bearings are illustrated, but other types of rolling elements could be substituted therefor.

1.-7. (canceled)

8. A steer-by-wire steering system for a motorized vehicle, comprising:
a driver input shaft; and
a feedback actuator configured to simulate a steering feel to a steering device, said feedback actuator comprising:
an electric motor comprising a motor shaft connected to the driver input shaft to be able to transmit a torque;
at least one rolling bearing in which said motor shaft is rotatably disposed, the rolling elements of the at least one rolling bearing arranged in a magnetorheological fluid; and
an electromagnet configured to pass a magnetic field through said magnetorheological fluid and, when actuated, stiffens said fluid and restricts movement of said rolling elements.

9. The steer-by-wire steering system of claim 8, wherein the electromagnet includes a ring-shaped coil.

10. The steer-by-wire steering system of claim 9, wherein the coil is arranged in at east one rolling bearing housing.

11. The steer-by-wire steering system of claim 10, wherein the at least one rolling bearing housing is filled with the magnetorheological fluid.

12. The steer-by-wire steering system of claim 8, wherein the motor shaft is rotatably disposed in an upper bearing and a lower bearing, wherein the upper bearing holds a free end of the motor shaft and the lower bearing is positioned at an opposite side of a rotor of the electric motor.

13. The steer-by-wire steering system of claim 12, wherein rolling elements of the lower bearing are arranged in the magnetorheological fluid.

14. The steer-by-wire steering system of claim 8, wherein the motor shaft includes a motor pulley as part of a transmission gear, wherein a belt is attached to the motor pulley, said belt configured to drive a pulley connected to the driver input shaft.
